(19) United States
(12) Patent Application Publication
(10) Pub. No.: US 2024/0361056 A1
(43) Pub. Date: Oct. 31, 2024

(54) HYBRID REFRIGERATION SYSTEM, CONTROL METHOD THEREOF AND TRANSPORTATION REFRIGERATION VEHICLE

(71) Applicant: Carrier Corporation, Palm Beach Gardens, FL (US)

(72) Inventors: Rong Hang, Shanghai (CN); Linhui Chen, Shanghai (CN); Yunhai Gao, Shanghai (CN)

(21) Appl. No.: 18/645,507

(22) Filed: Apr. 25, 2024

(30) Foreign Application Priority Data
Apr. 28, 2023 (CN) 202310483165.8

(51) Int. Cl. F25B 49/02; F25D 11/00

(52) U.S. Cl. CPC F25B 49/02; F25D 11/003

(57) ABSTRACT

A hybrid refrigeration system comprises: a liquid nitrogen based first refrigeration device for regulating the temperature of a cargo box of a transportation refrigeration vehicle; a mechanical based second refrigeration device for regulating the temperature of the cargo box of the transportation refrigeration vehicle; and a controller connected to the first refrigeration device and the second refrigeration device; wherein, the controller is configured to determine whether the difference between the temperature of the cargo box and the set temperature is greater than or equal to a first threshold when receiving a refrigeration demand for the cargo box; if so, start the first refrigeration device alone or start both the first refrigeration device and the second refrigeration device simultaneously; and if not, start the second refrigeration device alone.

### CROSS REFERENCE TO RELATED APPLICATIONS

This application claims priority to Chinese Patent Application No. 202310483165.8 filed on Apr. 28, 2023, which is incorporated by reference herein in its entirety.

### FIELD OF THE INVENTION

The invention relates to the field of refrigeration devices, and in particular to a hybrid refrigeration system, a control method thereof, and a transportation refrigeration vehicle.

### BACKGROUND OF THE INVENTION

The transportation refrigeration vehicles used in existing cold chain transportation generally use mechanical refrigeration devices. In order to reduce the temperature inside the cargo box to a set temperature quickly, the mechanical refrigeration device needs to have a large refrigeration capacity. Therefore, the mechanical refrigeration device itself and the devices that power it, such as combustion engines, lithium batteries, or fuel cells, need to be designed with a larger volume and weight.

On the other hand, liquid nitrogen refrigeration systems can achieve rapid cooling, but their cost is high and they are not suitable for long-distance transportation.

### SUMMARY OF THE INVENTION

Disclosed herein is a hybrid refrigeration system for a transportation refrigeration vehicle is provided, comprising:
a first refrigeration device for regulating a temperature of a cargo box of the transportation refrigeration vehicle, wherein the first refrigeration device is a liquid nitrogen based refrigeration device; and
a second refrigeration device for regulating the temperature of the cargo box of the transportation refrigeration vehicle, wherein the second refrigeration device is a mechanical refrigeration device;
a controller connected to the first refrigeration device and the second refrigeration device;
wherein, the controller is configured to determine whether a difference between the temperature of the cargo box and a set temperature is greater than or equal to a first threshold when receiving a refrigeration demand for the cargo box;
if so, start the first refrigeration device alone or start both the first refrigeration device and the second refrigeration device simultaneously; and
if not, start the second refrigeration device alone.

Optionally, when the first refrigeration device is started and the set temperature is reached, or when the difference between the temperature of the cargo box and the set temperature is less than the first threshold, the first refrigeration device is turned off and the second refrigeration device is used to maintain the temperature of the cargo box. Optionally, a selectable range of the first threshold is, for example, 2° C.-10° C., such as 3° C.-8° C.

Optionally, the first refrigeration device comprises a liquid nitrogen storage tank and a liquid nitrogen release control valve, where the first refrigeration device regulates the temperature of the cargo box by converting liquid nitrogen into nitrogen gas and transporting it to the cargo box, or the first refrigeration device further comprises a first cargo box heat exchanger, where the first refrigeration device regulates the temperature of the cargo box by converting the liquid nitrogen into nitrogen gas, passing it through the first cargo box heat exchanger and then discharging it to the environment.

Optionally, the second refrigeration device comprises a compressor, a condenser, a throttling device, and a second cargo box heat exchanger.

Optionally, the second refrigeration device is powered by a combustion engine, a lithium battery, or fuel cells.

Optionally, the first refrigeration device and the second refrigeration device share the same cargo box heat exchanger.

Optionally, in the event of a failure of either the first refrigeration device or the second refrigeration device, the other of the first refrigeration device or the second refrigeration device alone serves as a backup refrigeration device for temperature regulation of the cargo box.

Also disclosed is a transportation refrigeration vehicle comprising a hybrid refrigeration system as described above, wherein the transportation refrigeration vehicle is powered by a combustion engine, a lithium battery, or fuel cells, where the hybrid refrigeration system and the transportation refrigeration vehicle share an energy supply device or respectively comprise independent energy supply devices.

A control method for a hybrid refrigeration system is further provided, comprising:
determining whether a difference between a temperature of a cargo box and a set temperature is greater than or equal to a first threshold when receiving a refrigeration demand for the cargo box;
if so, starting a first refrigeration device based on liquid nitrogen alone or starting both the first refrigeration device based on liquid nitrogen and a second refrigeration device based on mechanical refrigeration simultaneously; and
if not, starting the second refrigeration device alone.

Optionally, the method further comprises: turning off the first refrigeration device and using the second refrigeration device to maintain the temperature of the cargo box when the first refrigeration device is started and the set temperature is reached, or when the difference between the temperature of the cargo box and the set temperature is less than the first threshold. Optionally, a selectable range of the first threshold is, for example, 2° C.-10° C., such as 3° C.-8° C.

The device and method according can reduce the requirement for the capacity of the mechanical refrigeration device on the vehicle, and thus reduce the weight and volume of the mechanical refrigeration device.

### BRIEF DESCRIPTION OF THE DRAWINGS

With reference to the accompanying drawings, the disclosure of the invention will become easier to understand. Those skilled in the art would easily understand that these drawings are for the purpose of illustration, and are not intended to limit the protection scope of the invention. In addition, in the figures, similar numerals are used to denote similar components, where:

FIG. 1 illustrates a schematic diagram of a transportation refrigeration vehicle;

FIG. 2 illustrates a schematic diagram of a transportation refrigeration vehicle;

FIG. 3 illustrates a schematic diagram of a transportation refrigeration vehicle; and

FIG. 4 illustrates a flowchart of a control method.

### DETAILED DESCRIPTION OF EMBODIMENT(S) OF THE INVENTION

A hybrid refrigeration system for a transportation refrigeration vehicle according to various embodiments of the present invention will first be described in conjunction with FIGS. 1 to 3. The transportation refrigeration vehicle can be used for cold chain transportation, including food, drugs, and the like, which mainly comprise a tractor 1, a trailer 2, and a cargo box 3 arranged on a platform defined by the tractor 1 and the trailer 2, with its interior used to store goods that need cold chain transportation. In addition, the transportation refrigeration vehicle also comprises a hybrid refrigeration system according to various embodiments of the present invention.

The hybrid refrigeration system according to the embodiment shown in FIG. 1 comprises: a first refrigeration device 5 for regulating the temperature of the cargo box 3, where the first refrigeration device 5 is a liquid nitrogen based refrigeration device; a second refrigeration device 4 for regulating the temperature of the cargo box 3, where the second refrigeration device 4 is a mechanical refrigeration device; and a controller connected to the first refrigeration device 5 and the second refrigeration device 4; wherein, the controller is configured to determine whether the difference between the temperature of the cargo box and a set temperature is greater than or equal to a first threshold when receiving a refrigeration demand for the cargo box; if so, start the first refrigeration device 5 alone or start both the first refrigeration device 5 and the second refrigeration device 4 simultaneously; and if not, start the second refrigeration device 4 alone. By using this hybrid refrigeration system, the first refrigeration device 5 based on liquid nitrogen can be used to reduce the temperature of the cargo box quickly when the difference between the temperature of the cargo box and the set temperature is large, while the second refrigeration device 4 is used to assist in cooling and maintaining temperature. This reduces the requirement for the refrigeration capacity of the second refrigeration device 4, thereby reducing the weight of various components of the second refrigeration device 4 based on mechanical refrigeration as well as the weight of the energy supply devices that power them. When the difference between the temperature of the cargo box and the set temperature is small, there is no need to start the first refrigeration device 5 and the second refrigeration device 4 is used to achieve temperature regulation. In some embodiments, the selectable range of the first threshold is, for example, 2° C.-10° C., and optionally, between, for example, 3° C.-8° C.

In some embodiments, the controller may be further configured to turn off the first refrigeration device 5 and use the second refrigeration device 4 to maintain the temperature of the cargo box when using the first refrigeration device 5 and the temperature of the cargo box is reduced to the set temperature. In alternative embodiments, the controller can otherwise be configured to turn off the first refrigeration device 5 when the difference between the temperature of the cargo box and the set temperature is less than the first threshold, and then the second refrigeration device 4 alone regulates the temperature of the cargo box. In the case of using the first refrigeration device 5 for cooling, the second refrigeration device 4 can be turned on at any time after receiving the refrigeration demand but before the first refrigeration device 5 being turned off. For example, the second refrigeration device 4 can be turned on simultaneously with the first refrigeration device 5 to achieve the fastest cooling, or turned on when the first refrigeration device 5 is turned off, thereby saving energy. In the device according to the present invention, as the second refrigeration device 4 is only used for maintaining temperature and a small load of cooling, the rated capacity, weight, and volume of the second refrigeration device 4 can be reduced compared to conventional mechanical refrigeration devices. In addition, the time required to lower the temperature of the cargo box to its set point when the refrigeration device is first started can also be reduced.

In some embodiments, the first refrigeration device 5 comprises a liquid nitrogen storage tank 51, a liquid nitrogen storage sink 52, a liquid nitrogen release control valve 53, a liquid nitrogen transfer pipeline 54, and a first cargo box heat exchanger 55. In the embodiment shown in FIG. 1, the first refrigeration device 5 regulates the temperature of the cargo box by converting the liquid nitrogen in the liquid nitrogen storage tank 51 into a gaseous state through the control valve 53, and exchanging heat with the air in the cargo compartment through the first cargo box heat exchanger 55 and then discharging it into the environment. With continued reference to FIG. 3, in an alternative embodiment, the first refrigeration device 5 can regulate the temperature of the cargo box by converting the liquid nitrogen into a gaseous state through the control valve 53 and directly transporting it to the interior of the cargo box 3. In such an embodiment, several pipelines and nozzles can also be arranged to allow nitrogen gas to enter the cargo box 3 more evenly. In the embodiment illustrated, the liquid nitrogen storage tank 51 of the first refrigeration device 5 is arranged in the trailer 2 below the cargo box 3, and the trailer 2 may comprise a liquid nitrogen replenishment interface to replenish liquid nitrogen at the station, or the liquid nitrogen storage tank 51 may be replaced after the journey is completed.

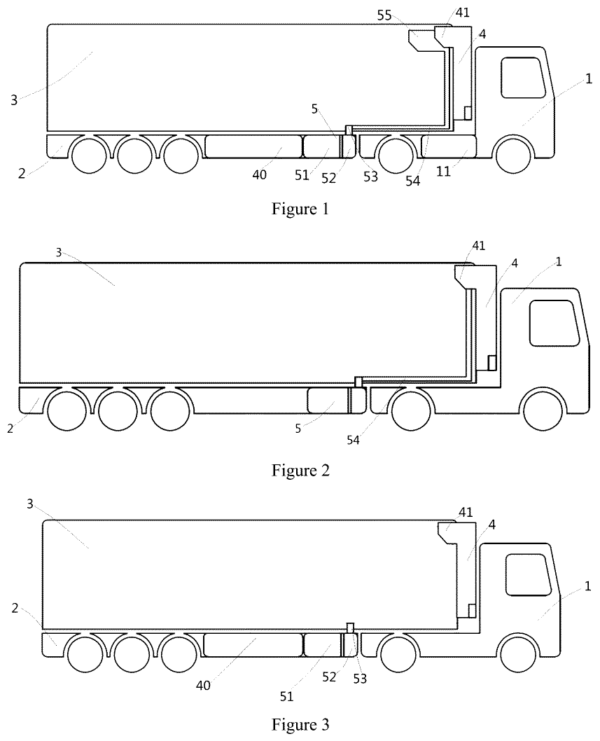

In some embodiments, the second refrigeration device 4 may comprise a compressor, a condenser, a throttling device, and a second cargo box heat exchanger 41 connected into a circulating circuit. That is, the second refrigeration device 4 comprises a traditional refrigeration circuit comprising a compressor. In the embodiment of FIG. 1, the second refrigeration device 4 is powered by a lithium battery 40. In alternative embodiments, fuel cells can also be used to replace the lithium battery 40. Or, as shown in FIG. 2, the second refrigeration device 4 can be powered by a traditional combustion engine. As mentioned above, due to the addition of the first refrigeration device 5 based on liquid nitrogen, the capacity of components, such as the compressor, in the second refrigeration device 4 can be reduced, and their weight and volume can also be reduced. In addition, the weight and volume of the lithium battery 40 that powers the second refrigeration device 4 can also be reduced, which is crucial for vehicles powered by new energy sources such as lithium batteries, as the reduced weight means longer range. For example, as shown in FIG. 1, the tractor 1 may include an additional lithium battery or fuel cells 11, which can help to achieve a longer range for the transportation refrigeration vehicle when the weight of the second refrigeration device 4 is reduced. In some embodiments, the second refrigeration device 4 may be arranged at the front of the cargo box 3, and the energy supply device 40 thereof may also be arranged in the trailer 2.

As shown in FIG. 2, in some embodiments, the first refrigeration device 5 and the second refrigeration device 4 may also share the same cargo box heat exchanger 41. The cargo box heat exchanger 41 may comprise a first flow path for discharging nitrogen gas into the environment and a second flow path for the refrigerant in the second refrigeration device 4, as well as a fan for facilitating heat exchange between the air in the cargo box and the nitrogen gas in the first flow path and the refrigerant in the second flow path. The pipeline 54 of the first refrigeration device can be connected to the first flow path. In addition, in some embodiments, the first refrigeration device 5 and the second refrigeration device 4 can serve as backup refrigeration systems for each other. That is, in the event of a failure of either the first refrigeration device 5 or the second refrigeration device 4, the other of the first refrigeration device 5 and the second refrigeration device 4 can alone serve as a backup refrigeration device for temperature regulation of the cargo box. That is, the controller is configured to use the one in normal operation to regulate the temperature inside the cargo box 3 in the event of a failure of the first refrigeration device 5 or the second refrigeration device 4, thus allowing the hybrid refrigeration system to cope with the failure of a single refrigeration device and try to preserve important goods being transported in the cargo box.

According to another aspect, for a transportation refrigeration vehicle, it may include a hybrid refrigeration system according to any of the above embodiments. The transportation refrigeration vehicle may be driven by a combustion engine, a lithium battery, or fuel cells, wherein the hybrid refrigeration system and the transportation refrigeration vehicle may share the combustion engine, the lithium battery, or the fuel cells, or they may have independent energy supply devices.

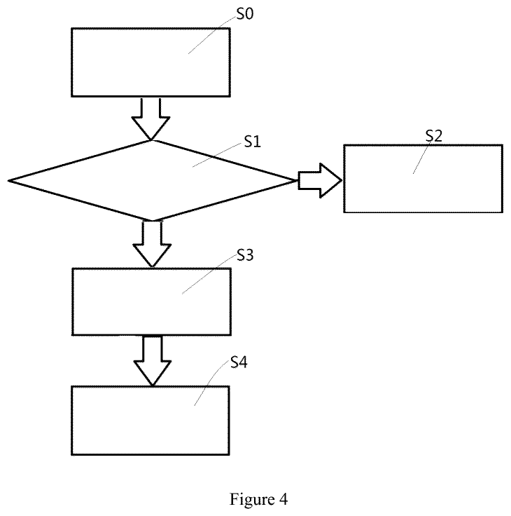

With continued reference to FIG. 4, a control method for a hybrid refrigeration system according to an embodiment of the present invention will be described. The control method may comprise: S0: receiving a refrigeration demand for a cargo box; S1: determining whether the difference between the temperature of the cargo box and a set temperature is greater than or equal to a first threshold; if not, proceed to step S2 to start the second refrigeration device alone; and if yes, proceed to step S3 to start the first refrigeration device based on liquid nitrogen alone or start both the first refrigeration device based on liquid nitrogen and the second refrigeration device based on mechanical refrigeration simultaneously. In some embodiments, the method further comprises: step S4: turning off the first refrigeration device and using the second refrigeration device to maintain the temperature of the cargo box when the first refrigeration device is started and the set temperature is reached, or when the difference between the temperature of the cargo box and the set temperature is less than the first threshold. Optionally, the selectable range of the first threshold is, for example, 2° C.-10° C., such as between 3° C.-8° C.

The specific embodiments described above are merely intended to describe the principles of the invention more clearly, wherein various components are clearly shown or described to facilitate the understanding of the principles of the invention. Those skilled in the art may, without departing from the scope of the invention, make various modifications or changes. Therefore, it should be understood that these modifications or changes should be included within the scope of patent protection of the invention.

What is claimed is:

1. A hybrid refrigeration system for a transportation refrigeration vehicle, comprising:
a first refrigeration device for regulating a temperature of a cargo box of the transportation refrigeration vehicle, wherein the first refrigeration device is a liquid nitrogen based refrigeration device; and
a second refrigeration device for regulating the temperature of the cargo box of the transportation refrigeration vehicle, wherein the second refrigeration device is a mechanical refrigeration device;
a controller connected to the first refrigeration device and the second refrigeration device;
wherein, the controller is configured to determine whether a difference between the temperature of the cargo box and a set temperature is greater than or equal to a first threshold when receiving a refrigeration demand for the cargo box;
if so, start the first refrigeration device alone or start both the first refrigeration device and the second refrigeration device simultaneously; and
if not, start the second refrigeration device alone.

2. The hybrid refrigeration system according to claim 1, wherein when the first refrigeration device is started and the set temperature is reached, or when the difference between the temperature of the cargo box and the set temperature is less than the first threshold, the first refrigeration device is turned off and the second refrigeration device is used to maintain the temperature of the cargo box, where optionally, the first threshold is selectable from a range of 2° C.-10° C., such as 3° C.-8° C.

3. The hybrid refrigeration system according to claim 1, wherein the first refrigeration device comprises a liquid nitrogen storage tank and a liquid nitrogen release control valve, where the first refrigeration device regulates the temperature of the cargo box by converting liquid nitrogen into nitrogen gas and transporting it to the cargo box, or the first refrigeration device further comprises a first cargo box heat exchanger, where the first refrigeration device regulates the temperature of the cargo box by converting the liquid nitrogen into nitrogen gas, passing it through the first cargo box heat exchanger and then discharging it to the environment.

4. The hybrid refrigeration system according to claim 1, wherein the second refrigeration device comprises a compressor, a condenser, a throttling device, and a second cargo box heat exchanger connected into a circulating circuit.

5. The hybrid refrigeration system according to claim 4, wherein the second refrigeration device is powered by a combustion engine, a lithium battery, or fuel cells.

6. The hybrid refrigeration system according to claim 1, wherein the first refrigeration device and the second refrigeration device share the same cargo box heat exchanger.

7. The hybrid refrigeration system according to claim 1, wherein in the event of a failure of either the first refrigeration device or the second refrigeration device, the other of the first refrigeration device or the second refrigeration device alone serves as a backup refrigeration device for temperature regulation of the cargo box.

8. A transportation refrigeration vehicle comprising a hybrid refrigeration system according to claim 1, wherein the transportation refrigeration vehicle is powered by a combustion engine, a lithium battery, or fuel cells, where the hybrid refrigeration system and the transportation refrigeration vehicle share an energy supply device or respectively comprise independent energy supply devices.

9. A control method for a hybrid refrigeration system, comprising:
determining whether a difference between a temperature of a cargo box and a set temperature is greater than or equal to a first threshold when receiving a refrigeration demand for the cargo box;
if so, starting a first refrigeration device based on liquid nitrogen alone or starting both the first refrigeration device based on liquid nitrogen and a second refrigeration device based on mechanical refrigeration simultaneously; and
if not, starting the second refrigeration device alone.

10. The control method according to claim 9, wherein the method further comprises: turning off the first refrigeration device and using the second refrigeration device to maintain the temperature of the cargo box when the first refrigeration device is started and the set temperature is reached, or when the difference between the temperature of the cargo box and the set temperature is less than the first threshold, where optionally, a selectable range of the first threshold is, for example, 2° C.-10° C., such as 3° C.-8° C.
